(19) United States
(12) Patent Application Publication
(10) Pub. No.: US 2006/0013759 A1
(43) Pub. Date: Jan. 19, 2006

(54) Systems and methods for hydrogen production

(75) Inventors: Yi Jiang, Horseheads, NY (US); Harold A. Wright, Ponca City, OK (US); Doug S. Jack, Ponca City, OK (US)

Correspondence Address: DAVID W. WESTPHAL;CONOCOPHILLIPS COMPANY - I.P. Legal, P.O. BOX 1267, PONONCA CITY, OK, 74602-1267, US

(73) Assignee: ConocoPhillips Company, Houston, TX (US)

(21) Appl. No.: 10/889,740

(22) Filed: Jul. 13, 2004

(51) Int. Cl. C01B 3/32; B01J 7/00

(52) U.S. Cl. 423/648.1; 48/61

(57) ABSTRACT

Disclosed herein are systems and methods for producing hydrogen in a reactor having a non-catalytic hydrogen selective permeable membrane in thermal contact with a reaction zone.

### RELATED APPLICATIONS

Not applicable.

### STATEMENT REGARDING FEDERALLY SPONSORED RESEARCH OR DEVELOPMENT

Not applicable.

### FIELD OF THE INVENTION

The present invention relates to a process for the preparation of hydrogen. More particularly, the present invention relates to the production of hydrogen from an exothermic reaction zone in a reactor having a non-catalytic hydrogen selective membrane in direct thermal contact with the reaction zone.

### BACKGROUND

Permeable materials are those through which gases or liquids may pass. Membranes are one type of permeable material and may be composed of thin sheets of natural or synthetic material. Frequently, membranes exhibit different permeances—i.e., permeation rates—for different chemical species. In this regard, permselectivity is the preferred permeation of one chemical species through a membrane with respect to another chemical species.

Permselective membranes are promising in a variety of applications including gas separation, electrodialysis, metal recovery, pervaporation and battery separators. Recently, interest has developed in using permselective membranes in so-called membrane reactors, which allow the simultaneous production and selective removal of products. One regime in which permselective membranes may be particularly promising is that of hydrogen production. The production of hydrogen (e.g., as a fuel cell fuel) may be of commercial interest.

Examples of reactions which produce hydrogen include:
CH₄+½O₂→CO+2H₂+Heat Partial Oxidation (1)
CH₄+H₂O+Heat→CO+3H₂ Steam Reforming (2)
CH₄+CO₂+Heat→2CO+2H₂ Dry (or CO₂) Reforming (3)

These reactions provide, inter alia, a pathway to convert carbon dioxide, a problematic greenhouse gas, and methane, a plentiful natural resource, into synthesis gas—i.e., a mixture of hydrogen and carbon monoxide. Synthesis gas is an industrially important feedstock that is used in the preparation of ethylene glycol, acetic acid, ethylene, fuels and several other commercially important chemicals. Additionally, these reactions can also be a source of hydrogen if hydrogen, rather than the syngas mixture, is the desired product.

Other examples of reactions that produce hydrogen gas are the decomposition of hydrogen sulfide (4) and ammonia (5):
H₂S [symbol] S(s)+H₂ (4)
2NH₃ [symbol] N₂+3H₂ (5)
Hydrogen sulfide and ammonia are frequent and undesirable byproducts of numerous chemical reactions. Thus, reactions (4) and (5), in addition to producing hydrogen, also offer an abatement technique for reducing the levels of these compounds. There may be a desire to develop systems and methods for producing substantially pure hydrogen using reactions such as reactions (1)-(5).

Systems have been developed for hydrogen production using catalytic membranes. However, catalytic membranes may be less than ideal because of the difficulty in activating the membranes, the propensity for carbon formation on the membrane, and the difficulty in regenerating the catalytic component of the membrane.

### SUMMARY

Disclosed herein are reactor systems comprising at least one reaction zone for producing hydrogen in a reaction zone and at least one non-catalytic selectively hydrogen permeable membrane which is at least in part in thermal contact with the reaction zone, wherein the hydrogen is produced by reacting a feed with an oxidant comprising molecular oxygen, and wherein at least a portion of the hydrogen produced is separated by the membrane and collected for further use. The reaction zone preferably comprises a catalytic bed. Some embodiments may include multiple reaction zones in thermal contact, some exothermic and some endothermic, for heat management, wherein at least a portion of each zone is in fluid contact with a non-catalytic selectively hydrogen permeable membrane. In yet other embodiments, one reaction zone may contain a catalytic partial oxidation reaction and another reaction zone comprises a reforming reaction. The hydrogen product is separated through at least one non-catalytic hydrogen selective permeable membrane and collected for further use.

The invention relates to a method for the production of hydrogen, the method comprising: (a) providing a reactor comprising a non-catalytic hydrogen selective permeable membrane and a reaction zone, wherein the non-catalytic hydrogen selective permeable membrane is at least partially in thermal contact with the reaction zone; (b) reacting an organic feed with an oxidant in the reaction zone to at least produce hydrogen and heat in the reaction zone; (c) allowing at least a portion of the hydrogen from the reaction zone to permeate through the non-catalytic hydrogen selective permeable membrane; and (d) collecting the hydrogen that permeates through the hydrogen selective permeable membrane. One embodiment comprises periodically alternating feed composition to the reaction zone so as to, in a first step, react an organic feedstock with the presence of molecular oxygen to produce heat and hydrogen for a given amount of time, and then in a second step, react an organic feedstock with the presence of steam and/or carbon dioxide with some of or all of the heat produced in the first step to produce hydrogen for a given amount of time and cycling between the first exothermic step and the second endothermic step. The organic feedstocks in the first and second steps could have the same component(s) or different components. In addition, the reaction zone may comprise one catalytic bed capable of promoting an exothermic reaction in the first step and an endothermic reaction in the second step. In some embodiments, the catalytic bed comprises one catalytic composition that can promote either an exothermic reaction or an endothermic reaction depending on the selection of the oxidant composition.

An alternate embodiment of the method for the production of hydrogen comprises: (a) providing a reactor comprising an exothermic reaction zone, an endothermic reaction zone, and a hydrogen collection zone, wherein the exothermic reaction zone is at least partially in thermal contact with the endothermic reaction zone; (b) reacting an organic feed with an oxidant comprising molecular oxygen in the exothermic reaction zone so as to produce heat and hydrogen in the exothermic reaction zone, wherein at least a portion of the produced heat is transferred to the endothermic reaction zone; (c) allowing at least a portion of the hydrogen from the exothermic reaction zone to permeate through a first non-catalytic hydrogen selective permeable membrane; (d) collecting the hydrogen that permeates through the first hydrogen selective permeable membrane; (e) reacting a feed with at least a portion of the transferred heat so as to produce hydrogen in the endothermic reaction zone; and (f) allowing at least a portion of the hydrogen produced in the endothermic reaction zone to permeate through a second non-catalytic selective hydrogen permeable membrane into a hydrogen collection zone. In preferred embodiments, a dividing element separates the exothermic and endothermic zones. The dividing element preferably allows heat transfer between the exothermic and endothermic reaction zones and creates a zone of thermal contact between them. In preferred embodiments, the dividing element prevents fluid communication between the exothermic and endothermic reaction zones. In alternate embodiments, the dividing element allows flow of gaseous components therethrough from one zone to the other.

The invention further relates to a system for producing hydrogen comprising: a means for reacting an organic feed with oxygen gas to produce heat and a product comprising hydrogen; a hydrogen recovery zone; and a means for allowing the selective permeation of at least a portion of the produced hydrogen in the presence of at least a portion of said produced heat into said hydrogen recovery zone, wherein the means for allowing is at least partially in thermal contact with the means for reacting. Preferably, the means for allowing the selective permeation of at least a portion of the produced hydrogen is at least partially in fluid communication with the means for reacting an organic feed. In preferred embodiments, the means for reacting an organic feed with oxygen gas comprises a partial oxidation reaction zone; more preferably, a catalytic partial oxidation reaction zone; while the means for allowing the selective permeation of at least a portion of the produced hydrogen comprises a non-catalytic hydrogen selective membrane. In some embodiments, the means for producing hydrogen further comprises a means for reacting a feedstream with an oxidant with at least a portion of said produced heat to form hydrogen.

The invention further relates to an apparatus for the production of hydrogen, the apparatus comprising a first reaction zone; a first non-catalytic selectively hydrogen permeable membrane at least partially in fluid and thermal contact with the first reaction zone a second reaction zone at least partially in thermal contact with the first reaction zone a second non-catalytic selectively hydrogen permeable membrane at least partially in fluid and thermal contact with the second reaction zone, and at least one hydrogen collection zone at least partially in fluid contact with the first and second non-catalytic selectively hydrogen permeable membranes. In preferred embodiments, both of the first and second reaction zones produce hydrogen. Additionally, the first zone comprises a self-sustaining reaction. Preferably, the first reaction zone comprises a heat source; and the second reaction zone comprises a heat sink. The heat sink preferably absorbs or utilizes some of the energy liberated from the heat source.

Other embodiments are within the spirit of the present invention and are disclosed herein or will be readily understood by those of ordinary skill in the art. All of these and other embodiments, features and advantages of the present invention will become apparent with reference to the following detailed description and drawings.

### BRIEF DESCRIPTION OF THE DRAWINGS

For a more detailed understanding of the present invention, reference is made to the accompanying Figures, wherein:

FIG. 1 is a schematic drawing comprising two reaction zones in thermal contact, two non-catalytic hydrogen selective permeable membranes, each of them in fluid contact with one of the reaction zones, and a hydrogen collection zone in accordance with embodiments of the present invention; and

FIG. 2 is a second schematic drawing comprising a reaction zone, a non-catalytic hydrogen selective permeable membrane in thermal and fluid contact with said reaction zone, and a hydrogen collection zone in accordance with embodiments of the present invention.

### DETAILED DESCRIPTION

There are shown in the Figures, and herein will be described in detail, specific embodiments of the present invention with the understanding that the present disclosure is to be considered an exemplification of the principles of the invention, and is not intended to limit the invention to that illustrated and described herein. The present invention is susceptible to embodiments of different forms or order and should not be interpreted to be limited to the particular methods, means or apparatus contained herein. In particular, various embodiments of the present invention provide a number of different configurations of the overall gas to liquid conversion process.

The present invention is generally related towards the production of hydrogen by the use of two reactions, each of which producing hydrogen, connected to a non-catalytic hydrogen selective permeable membrane, wherein at least one reaction further generates heat, a portion of which is utilized for the promoting of the second reaction, and another portion of which is utilized in the catalytic hydrogen selective permeable membrane for the promoting of the hydrogen permeation process.

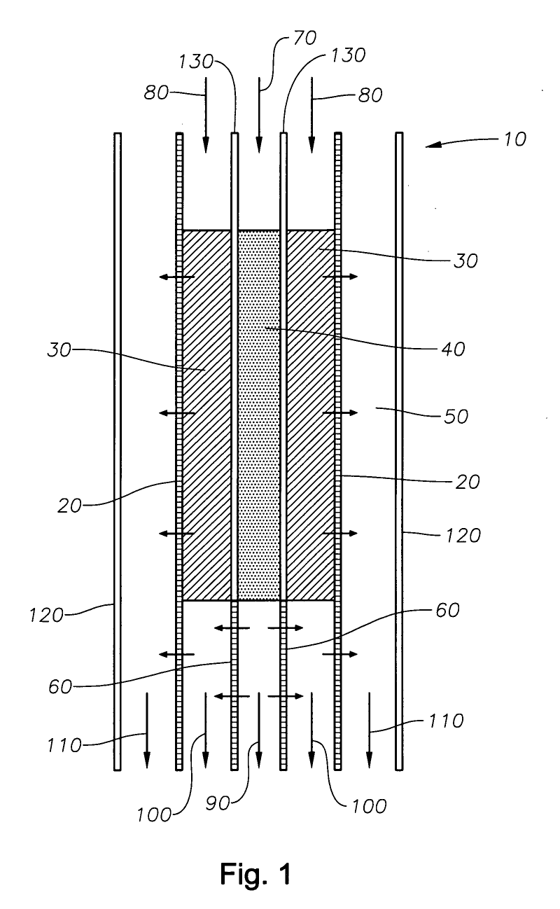

Referring to FIG. 1, there is shown a schematic drawing of an embodiment a reactor 10 of the present invention. Reactor 10 comprises an outer shell 120, an outer non-catalytic selective hydrogen permeable membrane 20, an outer reaction zone 30, an inner non-catalytic selective hydrogen permeable membrane 60, an inner reactor wall 130, an inner reaction zone 40, and a hydrogen recovery zone 50. Feeds 70 and 80 are fed into reaction zones 40 and 30 respectively. As used herein, the term “non-catalytic” means that the membrane does not catalyze the reactions occurring in the adjacent reaction zones. A non-catalytic membrane does not exclude membranes in which hydrogen is transported across the membrane via some chemical process. Non-catalytic membranes are intended to encompass membranes which perform both chemical (e.g., electrochemical) and physical transport of the hydrogen across the membrane.

Inner reaction zone 40 preferably comprises a heat source, while outer reaction zone 30 comprises a heat sink. The heat source is preferably an exothermic reaction. The heat sink is preferably an endothermic reaction. Although not illustrated, the opposite arrangement, wherein the inner reaction zone 40 comprises a heat sink, while outer reaction zone 30 comprises a heat source is also envisioned as an alternate configuration of FIG. 1. It is preferred to allow transfer of some of the heat from heat source in one zone to the heat sink in the other zone.

Outer shell 120 should not permit significant heat loss from reactor 10 and hence preferably comprise a refractory material so as to retain substantially all of the heat within reactor 10.

Inner reactor wall 130 is a dividing element, which separates inner reaction zone 40 and outer reaction zone 30. This dividing element preferably allows heat transfer between the two reaction zones 30 and 40 and creates a zone of thermal contact between them. Inner reactor wall 130 can provide a heat-transfer means between the two zones 30 and 40, so as to allow heat to transfer from one zone to another, preferably from inner reaction zone 40 to outer reaction zone 30. In some embodiments, this dividing element facilitates heat transfer from one reaction zone to another, preferably from zone 40 to zone 30. In preferred embodiments, inner reactor wall 130 further comprises a non-permeable dividing element which provides a mass-transfer barrier and prevents fluid communication between the two zones 30 and 40 so as to preclude mass flow of reactants and products through inner reactor wall 130. In preferred embodiments, inner reactor wall 130 comprises a thermally-conductive non-permeable dividing element. In alternate embodiments, inner reactor wall 130 comprises a thermally-conductive permeable dividing element, which allows heat transfer between zones, but also allows fluid communication between the two zones 30 and 40 (i.e., allow mass flow of components of gas phases in one reaction zone to another). Inner reactor wall 130 preferably defines the inner reaction zone 40. When inner reactor wall 130 has a tubular form, inner reaction zone 40 comprises at least a portion of the inner lumen of tubular inner reactor wall 130.

Inner non-catalytic selective hydrogen permeable membrane 60 preferably is contiguous to reactor wall 130 such that one end of membrane 60 is in contact with one end of wall 130. The adjoining of membrane 60 to wall 130 creates a continuous element. Membrane 60 and wall 130 could comprise similar cross-sectional area and shape, as shown in FIG. 1; alternatively they could comprise different cross-sectional areas and shapes. For example, if inner reactor wall 130 is of tubular form with a specific internal diameter, it is preferred that membrane 60 is also of tubular form with an internal diameter, which may be similar (preferred), smaller or bigger than that of tubular wall 130. If their diameters are different, there may be a need for wall 130 to have a transition area wherein its diameter changes so as to meet that of membrane 60 so wall 130 and membrane 60 can adjoin in a continuous manner. In the two-dimensional FIG. 1, membrane 60 and wall 130 are parallel and lined up with each other, and the adjoining of membrane 60 to wall 130 creates continuous straight lines; however it is envisioned that membrane 60 and wall 130 could be offset such that the adjoining of membrane 60 to wall 130 creates continuous lines with curvatures. The main distinguishing element between membrane 60 and reactor wall 130 is that membrane 60 allows the selective permeation of a gaseous product of the reaction (i.e., hydrogen) therethrough, while reactor wall 130 can inhibit or preclude mass flow of the gas phase components from one reaction zone to another; or alternatively can permit mass flow of most components of the gas phase from one reaction zone to another.

Outer reaction zone 40 is preferably located in at least a portion of the inner core region defined by inner reactor wall 130 and optionally (not shown) in at least a portion of the inner core region defined by membrane 60, so that zone 40 is surrounded on two of its ends by membrane wall 130 and optionally a portion of membrane 60. The other two ends of zone 40 comprise the zone inlet, through which feed 70 enters zone 40, and the zone outlet, through which the reaction zone effluent exits zone 40.

Outer reaction zone 30 is preferably located in at least a portion of the region between membrane 20 and inner reactor wall 130, so that zone 30 is surrounded on two of its ends by membrane 20 and wall 130. The other two ends comprise the zone inlet through which feed 80 enters zone 30 and the zone outlet through which the reaction zone effluent exits zone 30. If wall 130 and membrane 20 are both of tubular form so as to provide a concentric arrangement (i.e., their longitudinal axis coincide and membrane 20 has a greater diameter), the cross-sectional area of outer reaction zone 30 would have a ‘donut’ shape. Outer reaction zone 30 is preferably located in at least a portion of the annular zone between tubular membrane 20 and tubular wall 130.

Feed 70 preferably comprises molecular oxygen (O₂). Feed 70 preferably further comprise one or more organic compounds, such as a hydrocarbonaceous gas (e.g., natural gas; any C₁-C₄ hydrocarbon or any mixture of two or more thereof); any oxygenate, such as alcohols, esters, aldehydes, aldols, and the like; or any compound which is capable of undergoing an exothermic oxidation reaction to produce hydrogen. Feed 70 can be prepared by mixing a molecular oxygen (O₂) feedstock and an organic feedstock comprising at least one organic compound; alternatively, feed 70 could comprise separate (i.e., unmixed) organic and molecular oxygen feedstocks. The molecular oxygen feedstock may be air; O₂-enriched air; O₂ diluted with an inert gas (such as nitrogen gas, helium, argon, and the like); or substantially pure O₂. Preferably, the molecular oxygen feedstock is O₂ diluted with an inert gas (such as nitrogen gas, helium) or substantially pure O₂. The organic feedstock preferably comprises any C₁-C₄ hydrocarbon or a mixture of two or more thereof. In more preferred embodiments, the organic feedstock comprises at least 50% methane; still more preferably at least 80% methane; most preferably at least 90% methane. In some embodiments, the organic feedstock further comprises up to 10% ethane. In other embodiments, the organic feedstock comprises natural gas. In alternate embodiments, the organic feedstock comprises mostly ethane or a mixture of ethane and methane. In some embodiments, feed 70 can be prepared by mixing a methane-containing feedstock and an O₂-containing feedstock together in a carbon:O₂ molar ratio of about 1.5:1 to about 3.3:1, preferably about 1.7:1 to about 2.1:1, and more preferably about 2:1. Preferably the methane-containing feedstock is at least 80% methane, more preferably at least 90%. In alternate embodiments, the organic feedstock comprises an alcohol and/or any glycol-containing compound. Suitable non-limiting examples of alcohols comprise methanol, ethanol, propanol (iso- or n-), phenol, or mixtures of two or more thereof. In some embodiments, feed 70 has a sulfur content less than about 10 ppm sulfur. In other embodiments, feed 70 is substantially free of sulfur (i.e., less than about 1 ppm S). In alternate embodiments, when feed 70 has a sulfur content which can poison a catalyst present in reaction zone 40, feed 70 may be desulfurized prior to entering reaction zone 40. Desulfurization methods could comprise hydrodesulfurization; sorption by passing through a sorbant such as a zinc oxide-containing bed or an alkaline liquid). The methods of desulfurization are well known, and the selection of the desulfurization method(s) for feed 70 largely depends on the type and amounts of sulfur compounds that need to be removed from feed 70.

In preferred embodiments, reaction zone 40 comprises a partial oxidation reaction of a hydrocarbon gas with O₂, and for these embodiments, feed 70 can be prepared by mixing a hydrocarbon gas feedstock and an O₂-containing feedstock together in a carbon:O₂ molar ratio of about 1.5:1 to about 3.3:1, preferably about 1.7:1 to about 2.1:1, and more preferably about 2:1. Preferably the hydrocarbon gas feedstock is at least 80% methane, more preferably at least 90% methane; and the O₂-containing feedstock comprises at least 90% O₂, more preferably, is substantially pure oxygen gas.

Feed 70 is preferably gaseous prior to entering reaction zone 40. In some embodiments, feed 70 may comprise one or more vaporized organic compounds which would be in liquid form at ambient temperature and pressure, such as for example an alcohol (methanol, ethanol, propanol, phenol) or any glycol-containing compound. Feed 70 may be preheated prior to being fed to reaction zone 40. The preheating of feed 70 may be necessary to initiate the oxidation reaction in reaction zone 40 and/or to vaporize a liquid component of feed 70. The preheat temperature may vary depending on the composition of feed 70 and the conditions employed in reaction zone 40. In preferred embodiments, the preheat temperature of feed 70 may be between about 30° C. and about 750° C.; and is preferably between about 100° C. and about 500° C.; more preferably between about 150° C. and about 450° C.; still more preferably between about 200° C. and about 350° C.

In preferred embodiments, when reaction zone 40 comprises a partial oxidation catalyst, the preheated feed 70 passes through reaction zone 40 to the point at which the catalytic partial oxidation reaction initiates. An overall or net catalytic partial oxidation (CPOX) reaction ensues, and the reaction conditions are maintained to promote continuation of the process, which preferably is sustained autothermally. For the purposes of this disclosure, the term “net partial oxidation reaction” means that the partial oxidation reaction shown in Reaction 1, above, predominates. However, other reactions such as steam reforming (see Reaction 2), dry reforming (Reaction 3) and/or a water-gas shift reaction (as will be described later as Reaction 9) may also occur to a lesser extent in reaction zone 40. The relative amounts of the CO and H₂ in the reaction product mixture resulting from the catalytic net partial oxidation of feed 70 comprising O₂ and methane as the hydrocarbon gas are about 2:1H₂:CO, similar to the stoichiometric amounts produced in the partial oxidation reaction of Reaction 1. As used herein, the term “autothermal” means that after initiation of the partial oxidation reaction, no additional or external heat must be supplied to the catalyst in order for the production of synthesis gas to continue. Under autothermal reaction conditions the feed is partially oxidized and the heat produced by that exothermic reaction drives the continued net partial oxidation reaction. Consequently, under autothermal process conditions there is no external heat source required for reaction zone 40. The net partial oxidation reaction conditions are promoted by optimizing the concentrations of hydrocarbon gas and O₂ in feed 70, preferably within the range of about a 1.5:1 to about 3.3:1 ratio of carbon:O₂ by volume. In some embodiments, steam may also be added to produce extra hydrogen and to control the temperature at the outlet of reaction zone 40. The ratio of steam to carbon by volume ranges from 0 to 1. The carbon:O₂ ratio is the most important variable for maintaining the autothermal reaction and the desired product selectivities in reaction zone 40. Pressure, residence time, amount of feed preheat and amount of nitrogen dilution, if used, also affect the reaction products. The process also includes maintaining a catalyst residence time of no more than about 10 milliseconds for the gaseous feed 70. This is accomplished by passing the feed over, or through the porous structure of the catalyst system at a gas hourly space velocity greater than 20,000 hr⁻¹, preferably greater than 50,000 hr⁻¹. In certain embodiments, the step of maintaining net partial oxidation reaction promoting conditions in reaction zone 40 includes keeping the temperature of the feed 70 at about 30° C.-750° C. and keeping the temperature of the catalyst at about 600-2,000° C., preferably between about 600-1,600° C., by self-sustaining reaction. In some embodiments, the process includes maintaining the feed 70 at a preferred pressure of about 200-5,000 kPa (about 2-50 atmospheres), while contacting the catalyst.

Reaction zone 40 preferably comprises a catalytic bed; however, it is envisioned that a reaction zone 40, which is substantially catalyst-free would also be suitable for the present invention. A non-catalytic partial oxidation (POX) of methane, e.g., as described in Fong et al, U.S. Pat. No. 5,152,975, operation at high temperatures (greater than 1,300° C.) and high pressures (greater than 150 atm) may obtain high selectivities by reaction zone 40.

In preferred embodiments wherein the reaction zone 40 comprises a partial oxidation catalyst, the partial oxidation catalyst preferably includes a catalytic material comprising at least one metal chosen from the group consisting of iron (Fe), ruthenium (Ru), osmium (Os), cobalt (Co), rhodium (Rh), iridium (Ir), nickel (Ni), palladium (Pd), platinum (Pt), rhenium (Re), and any combination thereof. The catalytic material of the partial oxidation catalyst preferably comprises rhodium, nickel, iridium, rhenium, or any combination thereof. Combinations may include alloys of these metals. The preferred compositions for a partial oxidation catalyst for light hydrocarbons contain 0.5-10 wt % Rh, more preferably 0.5-5 wt % Rh. The catalytic material of the partial oxidation catalyst may further contain a rare earth element, such as a lanthanide. A “lanthanide” refers to a rare earth element selected from the group consisting of La, Ce, Pr, Nd, Pm, Sm, Eu, Gd, Tb, Dy, Ho, Er, Tm, Yb and Lu. The partial oxidation catalyst preferably comprises a lanthanide selected from the group consisting of lanthanum, samarium, praseodymium, neodymium; more preferably comprises samarium (Sm) and/or lanthanum (La). The lanthanide metal may be in an oxide form in the partial oxidation catalyst. The preferred compositions for a partial oxidation catalyst for light hydrocarbons further contain 0.5-10 wt % Sm or La, more preferably 2-8 wt % Sm or La. In certain preferred embodiments the ratio of rhodium to lanthanide is in the range of about 0.5-2. The lanthanide in the partial oxidation catalyst may be in elemental form, but preferably in oxide form and/or in formed complexes such as with components of a support. The partial oxidation catalyst may further comprise a support on which the catalytic material is deposited. The support preferably comprises a refractory material, such as zirconia, alumina, cordierite, titania, mullite, lanthanide-stabilized alumina, MgO-stabilized zirconia, MgO-stabilized alumina, silicon carbide, silicon nitride, niobia, or any mixture thereof. The support preferably has a BET surface area of at least 1 m²/gram of support. In preferred embodiments, the BET surface area of the support is preferably between about 1 m²/gram of support and about 50 m²/gram; more preferably between about 1 m²/gram of support and about 20 m²/gram. The preferred compositions for a partial oxidation catalyst for light hydrocarbons preferably contain an alumina-based refractory support. The support structure can be in the form of a monolith or can be in the form of divided or discrete structures or particulates. The term “monolith” as used herein is any singular piece of material of continuous manufacture such as solid pieces of metal or metal oxide or foam materials or honeycomb structures. The terms “discrete” structures, as used herein, refer to supports in the form of divided materials such as granules, beads, pills, pellets, cylinders, trilobes, extrudates, spheres or other rounded shapes, or another manufactured configuration. Alternatively, the divided material may be in the form of irregularly shaped particles. The catalytic bed in reaction zone 40 typically comprises of monolith, foam and/or large-sized catalyst particles, preferably the catalytic bed in reaction zone 40 comprises catalyst particles. Preferably at least a majority (i.e., >50%) of the particles or distinct structures have a maximum characteristic length (i.e., longest dimension) of less than six millimeters, preferably less than three millimeters. According to some embodiments, the divided catalyst structures have a diameter or longest characteristic dimension of about 0.25 mm to 6.35 mm (about 1/100″ to ¼″). In preferred embodiments, they are in the range of about 1 mm to about 4 mm. In other embodiments, they are in the range of about 50 microns to 1 mm.

Alternatively or additionally, reaction zone 40 may comprise some non-catalytic packing material. The non-catalytic packing material may provide enhanced heat transfer throughout reaction zone 40. For example, one might select a composition for the non-catalytic packing material, which confers a high thermal conductivity (i.e., greater than 40 W/mK at 25° C.) to said non-catalytic packing material. The non-catalytic packing material in the form of discrete structures (such as particles, pellets, trilobes, and the like) may be mixed with, or sandwiched between layers of, a particulate catalytic material to form reaction zone 40. A non-catalytic packing material can provide a diluent for reaction zone 40 comprising particulate catalytic material. For example, a high thermal conductivity material with excellent thermal shock resistance to high temperatures (such as greater than 700° C.) may be used as the non-catalytic packing material or a portion of the non-catalytic packing material to dissipate the heat formed by the catalytic exothermic reaction in reaction zone 40, so as to minimize hot spots formation within reaction zone 40 and facilitate removal of produced heat. A reaction zone 40, which is substantially free of catalytic material, could comprise a non-catalytic packing material.

Preferred exothermic reactions to take place in reaction zone 40 include partial oxidation of a hydrocarbon as Equation (6) shows below; and/or partial oxidation of an alcohol as Equation (7) with methanol shows below.
CₙHₘ+0.5nO₂→nCO+0.5mH₂+Heat (6)
CH₃OH+½O₂→CO₂+2H₂+Heat (7)

Reaction zone 40 should comprise conversion promoting conditions so as to convert at least a portion of feed 70 comprising molecular oxygen and at least one organic reactant (preferably a hydrocarbon gas) to generate hydrogen and an oxide of carbon, such as CO, CO₂, or mixtures thereof, and at the same time generate some heat of reaction. Suitable conversion promoting conditions in reaction zone 40 include a gas-phase temperature in the range of about 350° C. to about 2,000° C., preferably in the range of 400° C. to 2,000° C., more preferably in the range of 700° C. to 1,600° C., still more preferably in the range of 800° C. to 1,600° C.; a pressure in the range of about 100 kPa to about 5,000 kPa (about 1-50 atm), preferably from about 200 kPa to about 5,000 kPa (about 2-350 atm); more preferably from about 200 kPa to about 3,200 kPa (about 2-32 atm); and a gas hourly space velocity (GHSV) in the range of about 20,000 to about 100,000,000 hr⁻¹, more preferably of about 50,000 to about 25,000,000 hr⁻¹, still more preferably of about 100,000 to about 10,000,000 hr⁻¹, yet still more preferably of about 200,000 to about 1,000,000 hr⁻¹, most preferably of about 400,000 to about 800,000 hr⁻¹, wherein “space velocity” as that term is customarily used in chemical process descriptions, and is typically expressed as volumetric gas hourly space velocity in units of hr⁻¹.

Suitable examples of catalysts and reaction conditions for partial oxidation systems to be employed in reaction zone 40 to form hydrogen from catalytic partial oxidation of a hydrocarbon gas comprising methane are disclosed in U.S. Patent Publication No. 20020115730 to Allison et al.; in U.S. Pat. Nos. 6,402,989; 6,409,940; 6,461,539; 6,630,078; and 6,635,191; each of which is incorporated herein by reference in its entirety.

Feed 70, optionally preheated, is passed through reaction zone 40 under conversion promoting conditions so as to react some of the organic component with O₂ from feed 70 to generate heat and form a partial oxidation product comprising at least hydrogen. The partial oxidation product may further comprise an oxide of carbon, such as CO, CO₂, or mixtures thereof. In preferred embodiments, when feed 70 comprises O₂ and a hydrocarbon gas and passes through reaction zone 40 comprising suitable partial oxidation conversion promoting conditions, some of the hydrocarbon gas reacts with O₂ so as to generate heat and form a partial oxidation product comprising synthesis gas. The synthesis gas contains primarily hydrogen and carbon monoxide. Many other minor components may be present in the partial oxidation product, including steam, nitrogen, carbon dioxide, ammonia, hydrogen cyanide, hydrogen sulfide, etc., as well as unreacted feedstocks. In some embodiments when feed 70 has a low sulfur content (i.e., less than 10 ppmS), the partial oxidation product should also have a low sulfur content.

The partial oxidation product (preferably comprising at least produced H₂) exits reaction zone 40. At least a portion (preferably a substantial portion) of the produced H₂ from the partial oxidation product permeates through membrane 60. In preferred embodiments, the permeation of at least a portion of the produced hydrogen from the reaction zone 40 through the non-catalytic selective hydrogen permeable membrane 60 is performed continuously. Alternatively, the permeation of at least a portion of the produced hydrogen from zone 40 through membrane 60 is performed intermittently.

Some of the heat present in reaction zone 40 or present in partial oxidation product can also be transferred to membrane 60, such that membrane 60 attains a temperature that can facilitate or enhance the permeation of hydrogen from the partial oxidation product exiting reaction zone 40 to the membrane permeate side. The heat transfer to membrane 60 can comprise convective heat transfer from the hot partial oxidation product adjacent to membrane 60; and/or, if membrane 60 extends at least a portion of the length of reaction zone 40, radiant and conductive heat transfer from the solid material (i.e., catalyst particles and/or non-catalytic packing), which may be present in reaction zone 40. A suitable temperature for membrane 60 is expected to be above 500° C., preferably above 600° C. and up to 900° C., more preferably between about 700 and 900° C.

While at least a portion of formed hydrogen present in partial oxidation product permeates through membrane 60, other components of the partial oxidation product, and optionally the remainder of the produced H₂ not permeating through membrane 60, exit as effluent 90. Effluent 90 would typically contain an oxide of carbon such as CO and/or CO₂, optionally hydrogen (which has not permeated through membrane 60) and small amounts of the other minor components, such as unreacted components from feed 70. In preferred embodiments in which feed 70 comprises primarily a hydrocarbon gas and O₂ and reaction zone 40 comprises the selective oxidation of said hydrocarbon gas to synthesis gas, effluent 90 would typically contain very small amounts of CO₂, i.e., less than 5 vol %, preferably less than 2 vol %. In other embodiments in which feed 70 comprises primarily an alcohol and O₂, effluent 90 would typically contain large amounts of CO₂, and small amount of CO, i.e., less than 10 vol %, preferably less than 5 vol %.

Feed 80 may comprise a reforming feed stream (e.g., a hydrocarbonaceous compound; water and/or carbon dioxide). Feed 80 preferably comprises an oxidant selected from the group consisting of water, carbon dioxide (CO₂), and mixture thereof. Feed 80 further comprises one or more organic compounds, such as a hydrocarbonaceous gas (e.g., natural gas; any C₁-C₄ hydrocarbon or any mixture of two or more thereof); an oxygenate such as an alcohol or mixture of alcohols; or any organic compound which is capable to undergo an endothermic reaction with water, CO₂, or mixture thereof to produce hydrogen. Feed 80 can be prepared by mixing an organic feedstock comprising at least one organic compound and an oxidant feedstock comprising water and/or carbon dioxide; alternatively, feed 80 could comprise separate (i.e., unmixed) organic and oxidant feedstocks. Feed 80 preferably has a molecular oxygen content less than about 1,000 ppm O₂. In some embodiments, feed 80 has a low sulfur content (i.e., less than about 10 ppm S). In other embodiments, feed 80 is substantially sulfur free (i.e., less than about 1 ppm S). In alternate embodiments, when feed 80 has a sulfur content, which can poison a catalyst which is present in reaction zone 30, feed 80 may be desulfurized prior to entering reaction zone 30. Methods of desulfurization are well known, and suitable techniques have been described earlier for desulfurization of feed 70. In preferred embodiments, the organic feedstock in feed 80 comprises at least 50% methane; more preferably at least 80% methane; still more preferably at least 90% methane. In other embodiments, the organic feedstock in feed 80 comprises natural gas. In alternate embodiments, the organic feedstock in feed 80 comprises primarily ethane (i.e., more than 80% ethane by volume), or a mixture of ethane and methane. In additional embodiments, the organic feedstock in feed 80 comprises an oxygenate such as any alcohol and/or any glycol-containing compound. Suitable non-limiting examples of alcohols comprise methanol, ethanol, propanol (iso- or n-), phenol, or mixtures of two or more thereof.

Feed 80 is preferably gaseous prior to entering reaction zone 30. In some embodiments, feed 80 may comprise one or more vaporized components which would be in liquid form at ambient temperature and pressure, such as for example water; an alcohol (methanol, ethanol, propanol, phenol); or a glycol-containing compound. Feed 80 may be preheated prior to being fed to reaction zone 30. The preheating of feed 80 may be necessary to supply enough heat to initiate and/or sustain a reforming reaction in zone 30 and/or to vaporize one or more components of feed 80. The preheat temperature may vary depending on the composition of feed 80 and on the conditions employed in reaction zone 30. The preheat temperature of feed 80 is preferably between about 300° C. and about 900° C.; more preferably between about 400° C. and about 800° C.

Feed 80, optionally preheated, is fed into reaction zone 30, which may contain a reforming reaction promoting system (e.g., iron on a refractory support). Examples of reforming catalysts and reaction promoting systems for reaction zone 30 are disclosed in U.S. Patent Publication No. 20030066240 to Keller, which is incorporated herein by reference in its entirety. For a general discussion of steam reforming, dry (or CO₂) reforming, and partial oxidation, please refer to Harold Gunardson, “Industrial Gases in Petrochemical Processing”, pp. 41-80 (1998), the contents of which are incorporated herein by reference. Suitable conditions for operating a steam reforming reactor and a dry reforming reactor are disclosed in V. R. Choudhary et al., in Catalysis Letters (1995) vol. 32, pp. 387-390; S. S. Bharadwaj & L. D. Schmidt in Fuel Process, Technol. (1995) vol. 42, pp. 109-127; and Y. H. Hu & E. Ruckenstein, in Catalysis Reviews—Science and Engineering (2002) vol. 44(3), pp. 423-453, each of which is incorporated herein by reference in its entirety. Wang et al., “Carbon dioxide reforming of methane to produce synthesis gas over metal-supported catalysts: State of the Art, Energy and Fuels”, 10(1996) p. 896 (incorporated herein by reference) have provided a comprehensive summary of many of the catalysts used in the carbon dioxide reforming of methane. Preferably, steam reforming in reaction zone 30 is performed at a temperature in the range of about 500° C. to about 1,100° C.; more preferably in the range of about 600° C. to about 1,050° C. and still more preferably in the range of about 800° C. to about 1,100° C.; and at a pressure of from about 5 atm (about 500 kPa) to about 30 atm (about 3,000 kPa), preferably from about 20 atm (about 2,000 kPa) to about 30 atm (about 3,000 kPa). Steam reforming is strongly endothermic (energy intensive), requires high temperatures (greater than 800° C.) and high pressures (greater than 20 atm) to achieve acceptable yields. Dry (CO₂) reforming in reaction zone 30 preferably is performed at a temperature in the range of about 700° C. to about 1,000° C.; more preferably in the range of about 800° C. to about 950° C. and still more preferably in the range of about 850° C. to about 900° C.; and at a pressure of from about 1 atm (about 100 kPa) to about 10 atm (about 1,000 kPa), preferably from about 1 atm (about 100 kPa) to about 5 atm (about 500 kPa).

Hence, a suitable catalyst for the endothermic reaction zone 30 comprises a catalytically active metal selected from the group consisting of metals from groups 6, 7, 8, 9, 10 and 11 of the Periodic table (new IUPAC notation). A suitable steam reforming catalyst for methane in reaction zone 30 preferably comprises a catalytic metal selected from the group consisting of nickel, ruthenium, iridium, rhodium, platinum, palladium, chromium, copper, zinc, and any combination thereof; more preferably a catalytic metal selected from the group consisting of nickel, rhodium, chromium, copper, and any combination thereof supported upon a ceramic or refractory support. A suitable dry (CO₂) reforming catalyst for methane in reaction zone 30 comprises a catalytically active metal selected from the group consisting of metals from groups 6, 7, 8, 9, and 10 of the Periodic table, preferably ruthenium, iridium, rhodium, platinum, palladium, molybdenum, tungsten, rhenium and mixtures thereof supported upon a support such as silica, alumina, titania, MgO, zirconia, lanthana, NaY, and ZSM-5. A suitable steam reforming catalyst for methanol in reaction zone 30 comprises a catalytically active metal selected from the group consisting of one metal from Group 10 of the Periodic table, preferably platinum, or mixtures of a metal oxide from Group 6 and a metal from Group 11, such as Cu—ZnO disposed on a support, typically alumina. Catalysts for steam and dry reforming are commercially available from SudChemie, Louisville, Ky.; Engelhard Corporation, Iselin, N.J.; and Johnson Matthey, Wayne, Pa.

Alternatively or additionally, reaction zone 30 may comprise some non-catalytic packing material. The non-catalytic packing material may provide enhanced heat transfer throughout reaction zone 30, as previously described for reaction zone 40. A reaction zone 30 may be substantially free of catalytic material and could comprise a non-catalytic packing material. As a non-limiting example, a preheated gaseous alkane-containing feed 80 could be converted to alkenes and hydrogen (such as for example by Reaction 10 discussed later) while passing through or over an inorganic oxide material or a refractory material, such as alumina, zirconia, and the like, as long as generated heat from zone 40 can transfer to zone 30 and provide a sufficient temperature in zone 30 to sustain the dehydrogenation reaction.

Inner reactor wall 130 preferably provides a heat-transfer means between the two zones 30 and 40, so as to allow heat to transfer from one zone to another, preferably from inner reaction zone 40 to outer reaction zone 30. Hence, in preferred embodiments, at least a portion of the heat generated by the exothermic reaction in reaction zone 40 is transferred through inner reactor wall 130 to reaction zone 30, so the transferred heat can be used to at least partially drive the endothermic reaction(s) in reaction zone 30. The heat transfer from reaction zone 40 to reaction zone 30 can comprise radiant, convective and conductive heat transfer from any solid material (i.e., catalyst particles; non-catalytic packing material; or mixtures thereof), which may be present in reaction zone 40 to inner reactor wall 130; and/or from convective heat transfer from the hot gas present in reaction zone 40 to inner wall 130, as well as convective and conductive heat transfer from inner reactor wall 130 to reaction zone 30.

Inner reactor wall 130 is preferably made of a material suitable to conduct heat (with a high heat conductivity) and yet capable to withstand the temperature to which it is exposed while in direct thermal contact with parts of reaction zone 30. Examples of suitable materials for inner reactor wall 130 are inorganic oxides; metal alloys, especially high-melting point alloys; silicon carbide foams having a thermal conductivity of about 40 W/m K or higher; or high thermal conductivity carbon fibers or graphite foams, such as carbon fibers with a highly ordered graphite structure (for example, pitch-based carbon fibers with a thermal conductivity from 400 to 1100 W/mK or mesophase pitch-based graphite foams with a thermal conductivity of about 100 W/mK. It is preferred that inner reactor wall 130 does not permit passage of components of the gas phase from reaction zone 40 to reaction zone 30 (i.e., prevent fluid communication). Inner wall 130 is preferably impermeable to gaseous components present in both zones. Alternatively, inner wall 130 allows fluid communication of gaseous components. If inner reactor wall 130 allows flow of gaseous components therethrough, the permeable wall 130 should not favor the passage of specific compounds (reactants, products or inerts) from reaction zone 40 to zone 30.

The reforming product (preferably comprising at least produced H₂) exits reaction zone 30. The reforming product typically further comprises CO, CO₂, unconverted feedstocks, or mixture of two or more thereof. At least a portion of the H₂ formed in reaction zone 30 permeates through membrane 20 into hydrogen recovery zone 50. In preferred embodiments, the permeation of at least a portion of the produced hydrogen from the reaction zone 30 through the non-catalytic selective hydrogen permeable membrane 20 is performed continuously. Alternatively, the permeation of at least a portion of the produced hydrogen from zone 30 through membrane 20 is performed intermittently. The remainder of the reforming product not permeating membrane 20 (retentate) exits reactor 10 as effluent stream 100. Hydrogen is collected from hydrogen recovery zone 50 as stream 110 and is sent to its desired use (e.g., as fuel for a fuel cell or to another process requiring hydrogen).

Some of or all of the heat present in reaction zone 30 may be transferred to membrane 20, such that membrane 20 attains a temperature that can facilitate or enhance the permeation of hydrogen through it. The heat transfer from reaction zone 30 to membrane 20 can comprise radiant and conductive heat transfer from the solid material (i.e., catalyst particles), which may be present in reaction zone 30 and/or from convective heat transfer from the hot gas present in reaction zone 30. A suitable temperature for membrane 20 is expected to be above 500° C. and could be as high as 900° C.; preferably between about 600° C. and 900° C.

Preferred reactions to take place in reaction zone 30 may include steam reforming of a hydrocarbon as Equation (7) shows below; steam reforming of an alcohol as Equation (8) with methanol shows below; and/or dry reforming of a hydrocarbon illustrated with methane by Equation (3) shown earlier.
CₙHₘ+H₂O+heat→nCO+(0.5m+1)H₂ (7)
CH₃OH+2H₂O+heat CO₂+3H₂ (8)

The reforming of methane or methanol in reaction zone 30 especially in a fixed catalytic bed arrangement is limited by the reversibility of the reforming reaction. For a reversible reaction, preferential removal of one or more of the products during reaction typically causes a shift in equilibrium, thereby overcoming thermodynamic limitations. Membrane 20 can bring about such selective removal of hydrogen during reforming reaction which takes place in reaction zone 30 and hence the reactor system incorporating such non-catalytic hydrogen selective membrane 20 can be used to increase the reforming reaction yield. A reactor system such as is described in FIG. 1 incorporating non-catalytic product selective membranes offer advantages over conventional fixed-bed reactors (not comprising membranes) that include higher energy efficiency, lower capital and operating costs, compact modular construction, low maintenance cost, and ease of scale-up.

As shown in FIG. 1, membrane 60 begins at the downstream end of reaction zone 30. While this is one embodiment, membrane 60 may extend the entire length of reaction zone 40 or for only a portion of the length of reaction zone 40.

Likewise, membrane 20 is shown in FIG. 1 as extending the entire length of reaction zone 30. Membrane 20 may extend only a portion of the length of reaction zone 30 or may not begin until downstream of reaction zone 30.

Membranes 20 and 60 may be any acceptable selectively hydrogen permeable membrane; however it is preferred that membranes 20 and 60 do not carry any catalytic component so as not to convert the hydrogen permeate to products. Inorganic membranes have attracted much attention in the past decade because of their chemical, thermal and mechanical stability. The robustness of inorganic membranes compared to their polymeric counterparts permits their use in harsh environments such as chemical reactors. Polymeric membranes cannot be used at high temperatures and pressures: typical polymeric membranes cannot withstand temperatures in excess of 150° C. or pressure differentials in excess of several atmospheres. Consequently, these membranes have limited utility in applications such as reactor 10 employing high temperature and high pressure. Membranes 20 and 60 should exhibit a high permeability with respect to a reaction product (i.e., hydrogen) while maintaining a low permeability to the reactants and other reaction products. In short, suitable membranes for membrane 20 and 60 should provide both high selectivity for hydrogen—i.e., a high permselectivity and a high permeability for hydrogen. Hydrogen transport membranes, that are effective to separate hydrogen from hydrogen-containing gases, include membranes made of metals or metal alloys, proton-conducting ceramic materials and porous ceramic membranes. All of such membranes function at high temperatures. In metal-based and porous ceramic membranes, hydrogen permeation is due to the higher hydrogen partial pressure on the retentate side as compared to the permeate side. Several examples of metal-based membranes in the prior art include U.S. Pat. Nos. 3,350,846, 5,215,729, and 5,738,708. The membranes of the foregoing patents are composite membranes in which a layer, formed of metals from Group 4 or 5 of the Periodic Table of elements (new IUPAC notation), is sandwiched between two layers of a metal selected from either palladium, platinum or their alloys. In U.S. Pat. No. 5,217,506, a composite membrane is disclosed that contains intermetallic diffusion barriers between two top layers and a central membrane layer to prevent diffusion of top metal layer into the central metal layer. The barrier is made from oxides or sulfides of molybdenum, silicon, tungsten and vanadium. U.S. Pat. No. 5,652,020 describes a hydrogen transport membrane comprised of a palladium layer deposited on porous ceramic support layer. U.S. Pat. No. 5,415,891 describes a porous ceramic membrane modified by either metallic oxide (e.g., aluminum or zirconium oxide) or nonmetallic oxide (e.g., silicon oxide). Proton conducting ceramic materials can be characterized as being either electrically-driven (a pure proton conductor) or pressure driven (a mixed conductor). Electrically-driven membranes are pure proton conductors that do not have electrical conductivity. Such membranes need an external circuit to drive electrons from an anode surface of the membrane to cathode surface. One of the advantages of an electrically-driven membrane is that there is no need to maintain high pressure because electrical force can be used to transport hydrogen to the permeate zone and to produce pressurized hydrogen directly. A second advantage is the reduced need for a purge gas on the permeate side. Proton conducting ceramics suitable for high-temperature application include perovskite-type oxide based on cerates or zirconates as cited in H. Iwahara, “Hydrogen Pumps Using Proton Conducting Ceramics And Their Applications”, Solid State Ionics 125, pp 271-278 (1999). Pressure driven membranes capable of conducting both protons and electrons do not need external circuit and can operate in non-galvanic mode. Examples of mixed conducting, hydrogen transport membranes are disclosed in U.S. Pat. Nos. 6,066,307 and 6,037,514. U. Balachandran et al., “Development of Mixed-Conducting Ceramic Membrane for Hydrogen Separation”, presented at the Sixteenth Annual International Pittsburgh Coal Conference Proceedings, Pittsburgh, Pa., Oct. 11-15, 1999 discloses that electronic conductivity can be increased by mixing metal powder with mixed conductors such as partially substituted perovskite-type oxides such as CaZrO₃, SrCeO₃ and BaCeO₃. A suitable material for the hydrogen permeable membrane is the modified Vycor® glass material (Corning Incorporated, Corning, N.Y.) disclosed by Prabhu and Oyama, “Development of a Hydrogen Selective Ceramic Membrane and Its Application for the Conversion of Greenhouse Gases”, 1999 Chemical Letters (3) pp. 13-14 the contents of which are incorporated herein by reference in their entirety for all purposes. Preferred examples of acceptable hydrogen selective membranes are disclosed in U.S. Patent Publication No. 20030222015 to Oyama et al; U.S. Pat. No. 6,527,833 to Oyama et al.; and by Prabhu et al., in “Supported Nickel Catalysts for Carbon Dioxide Reforming of Methane in Plug Flow and Membrane Reactors”, Applied Catalysis A: General 241-52 (1999), each of which is incorporated herein by reference. Other acceptable membranes may be obtained from Eltron Research, Boulder, Colo. or Air Products, Allentown, Pa. It is preferred that membranes 20 and 60 have the ability to withstand temperatures of greater than 500° C., preferably from about 600 to about 900° C. The ability of membrane 60 to withstand temperatures of greater than 900° C. may be desirable. Indeed, many acceptable membranes, such as those disclosed in U.S. Patent Publication No. 20030222015 (to Oyama et al.) perform well at temperatures of 700° C.-800° C.

Membrane 40 and 60 preferably contain a thin film of silica, alumina, zirconia, titania, silicon nitride, silicon carbide or a zeolite. The film thickness typically ranges from 10 nanometers to about 25 microns. To assure the mechanical strength, the thin film is preferably supported on an inert, porous substrate at least 1 millimeter thick in the tubular form or sheet. Examples of porous substrate are porous metals, porous ceramics and porous refractory metal oxides, such as a porous alumina, porous modified alumina, porous titania, porous carbon, porous stainless steel, or porous Vycor® glass (Corning Incorporated, Corning, N.Y.) typically having pore sizes larger than about 40 nanometers (nm), preferably about 4-300 nm. The thin film is deposited on the porous substrate by various techniques, e.g., electroless-plating, electroplating, sputtering, chemical vapor deposition, sol-gel deposition, etc. Some of these membranes employ thin hydrogen-selective permeable films deposited on porous substrates without an intermediate layer between them, and sometimes are referred to herein as two-layer arrangements. Other membranes employ three-layer arrangements in which an intermediate layer is deposited between the thin layer and the porous substrate.

Membranes 20 and 60 must be capable of selectively passing hydrogen to the exclusion of the other components of the gas, preferably with a good flux. In preferred embodiments of the present invention, membranes 20 and 60 should exhibit high permselectivity for hydrogen while retaining a large hydrogen permeance. It is also preferable to maintain a hydrogen pressure differential across the membrane. It is desired that membranes 20 and 60 be able to withstand a pressure differential across the membrane of greater than 10 psi. The magnitude of the pressure differential across the membrane may be one factor which can modulate the rate of transport of hydrogen through the membrane. It is desirable that the pressure on the hydrogen collection side of the membrane be lower than the pressure on the retentate side of the membrane. Membranes 20 and 60 may comprise a similar composition, or may comprise a different composition.

With respect to reactor 10 of FIG. 1, feed streams 80 and 70 are shown fed into the same end of the reactor 10 (i.e., the flows of the respective feeds to the reaction zones are in the same direction) so that the reaction zones are arranged in an adjacent concurrent flow configuration. It is envisioned that in some embodiments, it may be desirable to pass the respective feeds to the reaction zones in opposite directions so that the reaction zones are arranged in an adjacent countercurrent flow configuration. One advantage of the adjacent countercurrent flow arrangement would be the optimization of heat transfer through the thermal contact area (portion of inner reactor wall 130) between the two reaction zones. Likewise, it may be desirable in some situations to remove the generated hydrogen from a point in the reactor 10 other than at the exit of each reaction zone. Such modifications are intended to be within the scope of the current invention. Additionally, it is envisioned that reaction zones 30 and 40 may be aligned (non-offset) as shown in FIG. 1, but could also be offset, i.e., the tops and/or bottoms of the reaction zones may not be aligned. Additionally, it is envisioned that reaction zones 30 and 40 could be of the same height as shown in FIG. 1, but could be of different heights (not shown); i.e., one of the reaction zones has a shorter length.

With respect to the reactions occurring within the reaction zones, the embodiments discussed herein describe one reaction zone, in which a catalytic partial oxidation occurs, which is in at least partial thermal contact with another reaction zone, in which a reforming reaction occurs, while both reaction zones generate hydrogen. It is also envisioned that it may be desirable to run other hydrogen producing reactions or that other reactions may also occur in the reaction zone 30 and/or 40. For example, the water gas shift reaction (9) may occur in addition to the partial oxidation and/or reforming reactions in reaction zones 30 and 40 respectively.
CO+H₂O [symbol] CO₂+H₂ (9)

Other oxidation reactions which can produce hydrogen may include the conversion of alkanes to alkenes (olefins), including the oxidative dehydrogenation, such as is disclosed in U.S. Patent Publication Nos. 20030040655, 20030065235, 20040010174, 20040068148, 20040068153, 20040072685, each of which is incorporated hereby by reference herein in its entirety, in the sense that they disclose catalysts and suitable conditions for operating an oxidative dehydrogenation process to convert gaseous alkanes to alkenes and hydrogen. An example of an endothermic dehydrogenation reaction is the conversion of alkane to alkene without oxygen addition, illustrated in (10) with ethane to ethylene.
C₂H₆+Heat→C₂H₄+H₂ (10)

As another example, it is expected that reaction zone 40 (e.g., a partial oxidation reaction zone) may have some reforming reactions occurring in said zone. However, the end result is the production of a product stream containing hydrogen. Some of or substantially all of the produced hydrogen in reaction zone 40 is then permeated through non-catalytic hydrogen selective membrane(s) so the permeated hydrogen can then be collected in hydrogen recovery zone 50 for use in some other process. The permeation of hydrogen through membranes 20 and 60 is preferably performed at a high temperature (greater than about 500° C.). The residual effluent stream (90 and/or 100) may be disposed of or used in any desirable manner.

In some embodiments, at least one effluent stream (90 and/or 100) from reactor 10 comprises carbon monoxide. In preferred embodiments, effluent stream 90 from reactor 10 comprises carbon monoxide. The effluent stream comprising carbon monoxide and exiting reactor 10 may be fed to a water-gas shift (WGS) reaction zone (not shown) comprising a water-gas shift catalyst under conversion promoting conditions so as to produce hydrogen. Water as well as a part of (or substantially all of) a reactor effluent stream containing CO (streams 90 and/or 100) is passed through said WGS reaction zone. Carbon monoxide and water come in contact with the WGS catalyst for a sufficient amount of time so that at least a portion of the carbon monoxide reacts with water in the presence of the water-gas shift catalyst to produce carbon dioxide and hydrogen as shown in reaction (9). The water is typically added as steam and mixed prior to exposure to the WGS catalyst with the part of (or substantially all of) the CO-containing the reactor effluent.

The WGS reaction zone can be operated from about 200° C. to about 1100° C., preferably from about 200° C. to about 450° C. The performance of a water gas shift reaction zone is independent of the operation of reaction zones 30 and 40. The operation of the water gas shift reaction zone can be selected based on the pressure of its gas feedstream and can range from atmosphere to 300 atmosphere. The temperature of the water gas shift reaction zone will ultimately depend on the WGS catalyst composition, the amount of conversion desired and the temperature of the incoming gas feedstream. Typically, the lower the temperature, the better the equilibrium conversion. Examples of WGS catalysts suitable for the present invention include but are not limited to iron-based catalysts and/or copper-based catalysts.

Low temperature shift catalysts operate at a range of from about 150° C. to about 300° C. Low temperature shift catalysts typically include, for example, copper oxide or copper supported on other transition metal oxides such as zirconia; and/or zinc supported on transition metal oxides or refractory supports such as silica, alumina, zirconia, and the like. Alternatively, a low temperature shift catalyst may include a noble metal such as platinum, rhenium, palladium, rhodium or gold on a suitable support such as silica, alumina, zirconia, and the like. A suitable (non-limiting) example of a low temperature shift catalyst is CuO/ZnO/Al₂O₃. The copper-based catalysts used in low temperature WGS catalysis tend to be unstable at the high temperature range; hence, the best operation temperature range for a copper-based shift catalyst is typically from 180° C. to 260° C. Above that range, the copper-based shift catalyst may start to deactivate due to sintering of the active component (comprising Cu).

High temperature shift catalysts are preferably operated at temperatures ranging from about 300° C. to about 600° C. High temperature shift catalysts can include one or more transition metal oxides such as ferric oxide and/or chromic oxide (for example, as a non-limiting example Fe₃O₄/Cr₂O₃), and optionally including a promoter such as copper or iron silicide. Also included as high temperature WGS catalysts are supported noble metals such as supported platinum, palladium and/or other platinum group members. The iron-based WGS catalysts are very stable, but have lower activities than the low-temperature WGS catalysts, which require their use at higher temperatures. Typically the operation temperature of iron-based WGS catalysts is in the range of 300-550° C.

The WGS reaction zone can include a packed bed of high temperature or low temperature shift catalyst such as described above, or a combination of both high temperature and low temperature shift catalysts. The WGS reaction zone should be operated at any temperature suitable for the water gas shift reaction, preferably at a temperature of from 150° C. to about 400° C. depending on the type of shift catalyst used.

Effluent 100 may exit from reaction zone 30 at a temperature greater than 700° C., while effluent stream 90 may exit from reactor 10 at a temperature greater than 800° C., sometimes greater than 900° C. The temperature of a reactor effluent (either in part or in its entirety) being fed to the water-gas shift reaction zone(s) is typically reduced to about 600° C. before entering the water-gas shift reaction zone(s).

Optionally, since lower temperatures favor the conversion of carbon monoxide and water to carbon dioxide and hydrogen, a cooling element such as a cooling coil may be disposed in the WGS reaction zone to lower the reaction temperature within the packed bed of WGS catalyst.

In one embodiment of the present invention, the WGS catalyst may comprises a high temperature WGS catalyst composition and a low temperature WGS catalyst composition in either successive WGS reaction zones or as a single catalyst mixture in a single WGS reaction zone. Additionally, a purification processing can be performed between high and low shift successive conversion zones by providing separate vessels for high temperature and low temperature shift conversion zones and, for example, a selective hydrogen removal between the separate high and low temperature shift vessels. Accordingly, one embodiment of the present invention comprises passing at least a portion of a reactor effluent comprising CO over a high temperature WGS catalyst at a temperature in the range of 300-560° C. so as to convert CO and H₂O to CO₂ and H₂ and to obtain a high-temperature WGS effluent; optionally, removing hydrogen from the high-temperature WGS effluent; cooling the high-temperature WGS effluent; passing said cooled high-temperature WGS effluent over a low WGS catalyst at a temperature in the range of 180-260° C. to further convert CO and water to CO₂ and H₂ and to obtain a low-temperature WGS effluent.

The water gas shift reaction zone is preferably operated so as to achieve a high hydrogen yield. The water gas shift reaction zone should convert more than 95% of CO to CO₂, preferably more than 98% CO. In some embodiments, the CO conversion in the water gas shift reaction zone is equal to or greater than 99% CO conversion. The water gas shift reaction zone preferably reduces the carbon monoxide content of the reaction zone effluent to less than 50 ppm CO, which is a suitable level for use of the resulting H₂-rich product stream in fuel cells. However, one of skill in the art should appreciate that the present invention can be adapted to produce a hydrogen-rich product with higher and lower levels of carbon monoxide. The so-obtained hydrogen-rich product stream exiting the water gas shift reaction zone(s) can then be used for any process that requires hydrogen and for which the performance is not greatly affected by carbon dioxide.

The hydrogen-rich stream exiting the water gas shift reaction zone(s) also contains carbon dioxide as a product from the water gas shift reaction. If the carbon dioxide would interfere with subsequent downstream processes and/or if a purer hydrogen stream is desired, the carbon dioxide removal could be carried out. Removal of carbon dioxide from a gas stream is well known in the art and is not critical to the present invention. A suitable non-limiting example of carbon dioxide removal includes amine scrubbing. Alternatively, a hydrogen selective membrane could be then again be used to recover a hydrogen product while a retentate stream would comprise mainly CO₂.

In addition to or alternatively, a portion of or most of effluent 90 which exits reactor 10 and has a small hydrogen content could be fed to reaction zone 30 so that some of its organic content could be further reacted in reaction zone 30 to produce additional hydrogen.

Although FIG. 1 illustrates concentric reaction zones 30 and 40, it is within the scope of the invention that the reaction zones may have different configurations, such as parallel zones separated by inner wall 130 in the form of a plate, slab, or sheet, as long as the reaction zones are in at least partial thermal contact. A parallel arrangement such as collection zone/endothermic zone/exothermic zone/collection zone can be repeated as long as there exists a means for collecting the hydrogen produced in each reaction zone by selective membrane permeation. The configuration should allow for some of the heat generated in the exothermic reaction zone to be transferred by radiation, convection and/or conduction to the endothermic zone to provide the heat necessary to promote the endothermic reaction, as well as for some of the generated heat to be transferred by convection, radiation and/or conduction to the non-catalytic selective membrane(s) to facilitate the permeation of generated hydrogen to the hydrogen recovery zone 50.

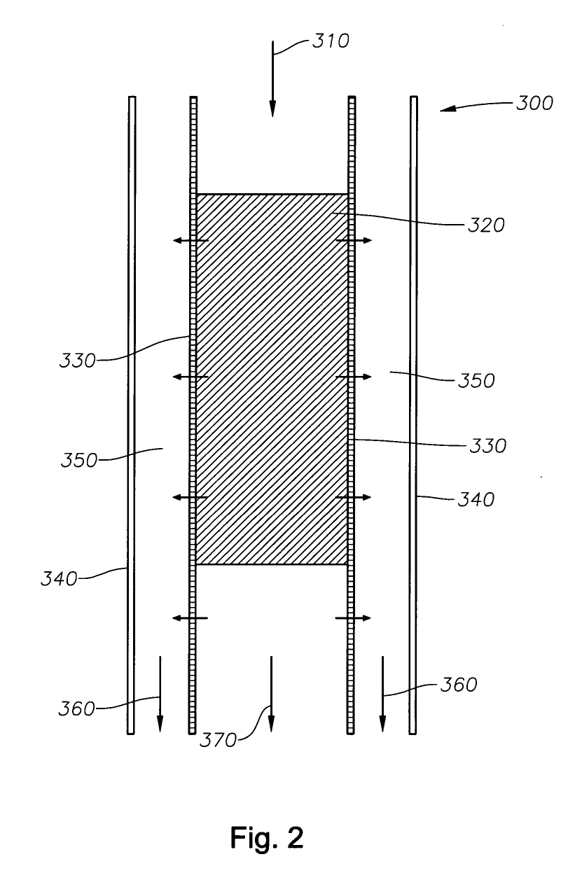

Referring now to FIG. 2, there is shown a schematic drawing of a second reactor 300 in accordance with alternate embodiments of the present invention. Reactor 300 comprises outer shell 340, selectively hydrogen permeable membrane 330, reaction zone 320, and hydrogen recovery zone 350. Feed stream 310 is fed into reaction zone 320 where it reacts to form a gas comprising H₂ and CO. At least a portion of the produced hydrogen permeates through membrane 330 into hydrogen recovery zone 350 and is collected as hydrogen stream 360. The remainder of the reaction product exits reaction zone 320 as effluent 370. Hydrogen membrane 330 may be any acceptable hydrogen selective membrane as disclosed above, such as those disclosed in U.S. Patent Publication No. 20030222015 to Oyama et al., and in “Supported Nickel Catalysts for Carbon Dioxide Reforming of Methane in Plug Flow and Membrane Reactors”, by Prabhu, et al., Applied Catalysis A: General 241-52 (1999), or commercially available from Eltron Research or Air Products, Allentown, Pa.

It is envisioned that reactor 300 may be operated in a steady state (i.e., house one constant reaction) or be operated in a dynamic state (i.e., the type of reactions are alternated). For example, in dynamic state, feed stream 310 may initially comprise the reactants necessary for an exothermic partial oxidation reaction as illustrated by, but not limited to, Equations (1), (5) and (6) and at some point be switched to endothermic reforming reactants. The residual heat in reaction zone 320 may be used to promote the endothermic reforming reaction as illustrated by, but not limited to, Equations (2), (3), (7), (8) and (10). Once the residual heat has been used, the reaction may again be switched to an exothermic reaction. In this reaction scheme, the catalyst in the reaction zone will be a catalyst to catalyze both reactions. For example, the catalyst may comprise a catalytic metal selected form the group consisting of nickel, nickel alloy, rhodium, rhodium alloy, or any combination thereof. Suitable metals for the rhodium alloy include but are not limited to ruthenium, iridium, platinum, rhenium, tungsten, niobium, tantalum and zirconium, preferably ruthenium and/or iridium. The catalyst able to promoted reforming/partial oxidation alternating steps is preferably supported on a refractory support such as but not limited to modified alumina, partially-stabilized alumina, stabilized alumina, unmodified alumina, titania, zirconia-toughened alumina, stabilized zirconia, modified zirconia, partially-stabilized zirconia, unmodified zirconia, silicon carbide, silicon nitride, aluminum nitride and any combinations of two or more thereof. When the catalyst comprises a rhodium alloy and is supported, the support material comprises primarily a refractory support material selected from modified, partially stabilized alumina, stabilized alumina, partially stabilized zirconia, stabilized zirconia, and combination thereof.

In a preferred embodiment of FIG. 2 operated in a two-step reaction cycle, feed 310 in one step comprises O₂ and a light hydrocarbon (such as methane, any hydrocarbon with 2 to 4 carbon atoms, or natural gas) and/or an alcohol to provide reactants for a partial oxidation reaction; whereas feed 310 in a successive step comprises steam and/or carbon dioxide, and a light hydrocarbon (such as methane, any hydrocarbon with 2 to 4 carbon atoms, or natural gas) and/or an alcohol to provide reactants for a reforming reaction.

At all times, hydrogen is removed through membrane 330. It is also envisioned that the removal of hydrogen may also shift the equilibrium of the reaction, which may beneficially result in higher yields, particularly with respect to endothermic reforming reactions.

In preferred embodiments, effluent stream 370 from reactor 300 comprises carbon monoxide. The CO-containing effluent stream 370 exiting reactor 300 may be fed, in part or in totality, to a water-gas shift (WGS) reaction zone (not shown) comprising a water-gas shift catalyst under conversion promoting conditions so as to produce hydrogen. Water (or steam) and the CO-containing effluent stream 370 are passed through the WGS reaction zone for a sufficient amount of time so that at least a portion of the carbon monoxide reacts with steam in the presence of the water-gas shift catalyst to produce carbon dioxide and hydrogen as shown in reaction (9). Suitable catalysts and operating conditions for the WGS reaction zone are the same as those described earlier for the effluent stream(s) of reactor 10 in FIG. 1.

It is envisioned that, in addition to free standing units, some embodiments of reactors of the present invention may be incorporated into other processes and/or small enough to fit on an offshore oil rig or the trailer of an 18 wheel truck.

While preferred embodiments of the invention have been shown and described, modifications thereof can be made by one skilled in the art without departing from the spirit and teachings of the invention. The embodiments described herein are intended to be exemplary only, and are not intended to be limiting. Many variations and modifications of the processes are possible and are within the scope of this invention. Accordingly, the scope of protection is not limited to the embodiments described herein, but is only limited by the claims that follow, the scope of which shall include all equivalents of the subject matter of the claims. In addition, unless order is explicitly recited, the recitation of steps in a claim is not intended to require that the steps be performed in any particular order, or that any step must be completed before the beginning of another step. Additionally, to the extent that any disclosure incorporated herein conflicts with the express teachings of the current specification or renders any part of the current disclosure unclear, the present specification shall take precedence

What is claimed is:

1. A method for the production of hydrogen, the method comprising:
(a) providing a reactor comprising a non-catalytic selective hydrogen permeable membrane and a reaction zone, wherein the non-catalytic selective hydrogen permeable membrane is at least partially in thermal contact with the reaction zone;
(b) reacting a feed comprising an organic compound with an oxidant comprising molecular oxygen in the reaction zone to produce hydrogen and heat in the reaction zone;
(c) allowing at least a portion of the hydrogen from the reaction zone to permeate from the reaction zone through the non-catalytic selective hydrogen permeable membrane; and
(d) collecting the hydrogen that permeates through the selective hydrogen permeable membrane.

2. The method of claim 1 wherein the non-catalytic selective hydrogen permeable membrane at least partially encloses the reaction zone.

3. The method of claim 1 wherein the organic feed comprises primarily methane.

4. The method of claim 1 wherein the organic feed comprises at least one compound selected from the group consisting of any alcohol and any C₁-C₄ hydrocarbon.

5. The method of claim 1 wherein the reaction in step (b) comprises a catalytic partial oxidation reaction.

6. The method of claim 5 wherein the catalytic partial oxidation reaction is catalyzed by a catalyst comprising a metal chosen from the group of Fe, Ru, Os, Co, Rh, Ir, Ni, Pd, Pt, Re, and combinations thereof.

7. The method of claim 6 wherein the catalyst comprises rhodium, and further comprises a lanthanide metal or lanthanide metal oxide.

8. The method of claim 1 wherein the reaction zone contains a catalyst comprising a metal selected from the group of Rh, Ni, Ir, Ru, and combinations thereof.

9. The method of claim 1 wherein the reaction in step (b) further produces carbon monoxide.

10. The method of claim 9 wherein the method further comprises passing at least a portion of the produced carbon monoxide over a water gas shift catalyst under conversion promoting conditions so as to convert CO in the presence of water to carbon dioxide and hydrogen.

11. The method of claim 1 wherein step (b) comprises
(b1) feeding an oxidant comprising O₂; and
(b2) reacting the organic compound with O₂ in the reaction zone to produce hydrogen and heat in the reaction zone.

12. The method of claim 11 wherein step (b) further comprises
(b1) stopping feed of oxidant comprising O₂;
(b2) feeding a second oxidant comprising water, carbon dioxide, or mixture thereof; and
(b3) reacting the organic compound with the second oxidant in the reaction zone with some of the heat produced in step (b2) to produce hydrogen in the reaction zone.

13. The method of claim 1 wherein step (c) is performed in the presence of at least a portion of said produced heat from step (b).

14. The method of claim 1 wherein the collected hydrogen is used as a fuel to power a fuel cell.

15. The method of claim 1 wherein step (c) comprises continuously permeating at least a portion of the hydrogen from the reaction zone through the non-catalytic selective hydrogen permeable membrane.

16. A method for the production of hydrogen, the method comprising:
(a) providing a reactor comprising a first reaction zone, a second reaction zone, and a hydrogen collection zone, wherein the first reaction zone is at least partially in thermal contact with the second reaction zone;
(b) reacting an organic feed with an oxidant comprising molecular oxygen in the first reaction zone so as to produce heat and hydrogen in the first reaction zone, wherein at least a portion of the produced heat is transferred to the second reaction zone;
(c) allowing at least a portion of the hydrogen from the first reaction zone to permeate through a first non-catalytic selective hydrogen permeable membrane;
(d) collecting the hydrogen that permeates through the first selective hydrogen permeable membrane into a hydrogen collection zone;
(e) reacting a feed with at least a portion of the transferred heat so as to produce hydrogen in the second reaction zone; and
(f) allowing at least a portion of the hydrogen produced in the second reaction zone to permeate through a second non-catalytic hydrogen permeable membrane into a hydrogen collection zone.

17. The method of claim 16 wherein the first reaction zone comprises a partial oxidation catalyst.

18. The method of claim 17 wherein the partial oxidation reaction catalyst comprises a metal selected from the group consisting of Fe, Ru, Os, Co, Rh, Ir, Ni, Pd, Pt, Re, and combinations thereof.

19. The method of claim 17 wherein the organic feed comprises at least one compound selected from the group consisting of any C1-C4 hydrocarbon, an alcohol, a sugar, and any glycol-containing compound.

20. The method of claim 17 wherein the organic feed comprises primarily methane.

21. The method of claim 16 wherein the second reaction zone comprises a reforming reaction.

22. The method of claim 21 wherein the endothermic reaction is catalyzed by a metal selected from the group consisting of nickel, rhodium, chromium, copper, and any combination of two or more thereof.

23. The method of claim 16 wherein the second reaction zone surrounds the first reaction zone.

24. The method of claim 2 wherein step (c) is performed in the presence of at least a portion of said produced heat from step (b).

25. The method of claim 16 wherein the reaction in step (b) further produces carbon monoxide.

26. The method of claim 25 wherein the method further comprises passing at least a portion of the produced carbon monoxide over a water gas shift catalyst under conversion promoting conditions so as to convert CO in the presence of water to carbon dioxide and hydrogen.

27. A system for producing hydrogen, the system comprising:
a means for reacting a gas comprising an organic compound to produce heat and a product comprising hydrogen;
a hydrogen recovery zone; and
a means for allowing the selective permeation of at least a portion of the produced hydrogen in the presence of at least a portion of said produced heat into the hydrogen recovery zone,
wherein the means for allowing is at least partially in thermal contact with the means for reacting.

28. The system of claim 27 wherein the gas comprises at least one organic compound selected from the group consisting of an alcohol; a sugar; any C₁-C₄ hydrocarbon; and any glycol-containing compound.

29. The system of claim 27 wherein the gas comprises any C₁-C₄ hydrocarbon or a mixture of two or more thereof.

30. The system of claim 27 wherein the gas comprises primarily methane.

31. The system of claim 27 wherein the means for reacting comprises a catalytic partial oxidation zone.

32. The system of claim 27 wherein the means for allowing the selective permeation of the hydrogen performs a physical separation of the produced hydrogen.

33. The system of claim 27 wherein the means for allowing the selective permeation of the hydrogen performs an electrochemical separation of the produced hydrogen.

34. The system of claim 27 further comprising a means for reacting a gas comprising an organic compound with at least a portion of said produced heat to form hydrogen.

35. The system of claim 34 wherein the means for reacting comprises a reforming zone.

36. An apparatus for the production of hydrogen, the apparatus comprising:
a first reaction zone,
a first non-catalytic selectively hydrogen permeable membrane at least partially in fluid and thermal contact with the first reaction zone,
a second reaction zone, said second reaction zone being at least partially in thermal contact with the first reaction zone;
a second non-catalytic selectively hydrogen permeable membrane at least partially in fluid and thermal contact with the second reaction zone, and
at least one hydrogen collection zone at least partially in fluid contact with the first and second non-catalytic selectively hydrogen permeable membranes.

37. The apparatus according to claim 36 wherein the first and second non-catalytic selectively hydrogen permeable membranes are inorganic membranes.

38. The apparatus according to claim 36 wherein the first reaction zone comprises a self-sustaining reaction.

39. The apparatus according to claim 36 wherein the first reaction zone comprises a heat source and the second reaction zone comprises a heat sink.

40. The apparatus according to claim 36 wherein the first and second reaction zones produce hydrogen.

41. The apparatus according to claim 36 wherein the first reaction zone produces heat.

42. The apparatus according to claim 36 wherein the first reaction zone comprises a partial oxidation catalyst.

43. The apparatus according to claim 36 wherein the second reaction zone comprises a reforming catalyst.

44. The apparatus according to claim 36 wherein the first reaction zone is suitable for passing a reactant gas at a gas hourly space velocity is in the range of about 50,000 hr⁻¹ to about 25,000,000 hr⁻¹.

45. The apparatus according to claim 36 further comprising a dividing element between the first and second reaction zone.

46. The apparatus according to claim 45 wherein the dividing element allows heat transfer from one reaction zone to the other reaction zone.

47. The apparatus according to claim 45 wherein the dividing element prevents fluid communication between the first and second reaction zones.
